(19) United States
(12) Patent Application Publication
(10) Pub. No.: US 2023/0051380 A1
(43) Pub. Date: Feb. 16, 2023

(54) USB PORT CONTROLLER AND ELECTRONIC APPARATUS

(71) Applicant: ROHM Co., LTD., Kyoto (JP)

(72) Inventor: Nobutaka Itakura, Kyoto (JP)

(21) Appl. No.: 17/818,022

(22) Filed: Aug. 8, 2022

(30) Foreign Application Priority Data
Aug. 10, 2021 (JP) 2021-130923

(51) Int. Cl. H02J 7/00; H02J 7/34

(52) U.S. Cl. CPC H02J 7/00712; H02J 7/345; H02J 7/0063

(57) ABSTRACT

Disclosed herein is a USB port controller on a sink side. The USB port controller is compatible with a USB Type-C. A sink equipped with the USB port controller includes a power supply terminal, a capacitor connected to the power supply terminal, and a discharge resistance and a discharge switch connected in series with each other between the power supply terminal and a ground line. The USB port controller includes a discharge control unit configured to turn on the discharge switch when no voltage is supplied from a source to the power supply terminal.

### CROSS REFERENCE TO RELATED APPLICATIONS

This application claims priority benefit of Japanese Patent Application No. JP 2021-130923 filed in the Japan Patent Office on Aug. 10, 2021. Each of the above-referenced applications is hereby incorporated herein by reference in its entirety.

### BACKGROUND

The present disclosure relates to a controller for a universal serial bus (USB) Type-C.

Battery driven devices including smart phones, tablet terminals, notebook computers, portable audio players, and digital cameras include, together with a rechargeable secondary battery, a charging circuit for charging the secondary battery. Some charging circuits charge a secondary battery on the basis of a DC voltage (bus voltage V_{BUS}) externally supplied via a USB cable or a direct current (DC) voltage from an external alternate current (AC) adapter.

A standard referred to as USB Power Delivery (which standard will hereinafter be referred to as a USB-PD standard) has been developed as a feeding system using a USB. In the USB-PD standard, suppliable power is greatly increased from 7.5 W of a battery charging (BC) standard to a maximum of 100 W. Specifically, the USB-PD standard allows the supply of a voltage higher than 5 V (specifically, 9 V, 12 V, 15 V, 20 V, etc.) as a USB bus voltage, and allows the supply of a larger amount as a charging current (specifically, 2A, 3A, 5A, etc.) than in the BC standard. The USB-PD standard is adopted also in a USB Type-C standard.

FIG. 1 is a block diagram of a feeding system 100R. The feeding system 100R is compliant with the USB Type-C standard. The feeding system 100R includes a feeding device (referred to also as a source or a host) 200R and a power receiving device (referred to also as a sink or a device) 300R connected to each other via a USB cable 106.

The feeding device 200R is included in an electronic apparatus 102. The electronic apparatus 102 may be an AC adapter. The power receiving device 300R is included in a battery driven electronic apparatus 400 such as a smart phone, a tablet terminal, a digital camera, a digital video camera, or a portable audio player.

The feeding device 200R includes a power supply circuit 202, a feeding side PD controller (hereinafter referred to as a feeding side controller) 204, and a bus switch SW1. The USB cable 106 is detachably connected to a receptacle 108 of the electronic apparatus 102. Incidentally, there is also a charge adapter in which the receptacle 108 is omitted and the USB cable 106 is integral with the electronic apparatus 102.

The receptacle 108 includes a VBUS terminal for supplying a bus voltage V_{BUS}, a GND terminal for supplying a ground voltage V_{GND}, and a configuration channel (CC) port. In actuality, two CC ports are provided. However, the CC ports are illustrated in a simplified manner as one CC port in FIG. 1. The power supply circuit 202 generates the bus voltage V_{BUS}. The power supply circuit 202 may include an AC/DC converter that receives AC 100 V from an external power supply (for example, a commercial alternating-current power supply) not illustrated and converts AC 100 V into a direct-current bus voltage V_{BUS}. The bus voltage V_{BUS} generated by the power supply circuit 202 is supplied to the power receiving device 300R via a bus line of the USB cable 106 and the bus switch SW1.

The feeding side controller 204 and a power receiving side controller 310 are each a port controller for a USB Type-C. The feeding side controller 204 and the power receiving side controller 310 are connected to each other via a CC line, and provide a communicating function. The feeding side controller 204 and the power receiving side controller 310 negotiate the voltage level of the bus voltage V_{BUS} to be supplied by the feeding device 200R. The feeding side controller 204 controls the power supply circuit 202 so as to provide the determined voltage level, and performs on-off control of the bus switch SW1.

The electronic apparatus 400 includes a battery 402, a receptacle 404, a load (system) circuit 406, and the power receiving device 300R. The battery 402 is a rechargeable secondary battery. The load circuit 406 includes a central processing unit (CPU), a memory, a liquid crystal display, an audio circuit, etc. The electronic apparatus 102 is detachably connected to the receptacle 404 via the USB cable 106.

The power receiving device 300R receives power from the electronic apparatus 102, and charges a charging circuit 302. The power receiving device 300R includes the charging circuit 302, the power receiving side controller 310, and a bus switch SW2.

The charging circuit 302 receives the bus voltage V_{BUS} from the feeding device 200R (on the power receiving device 300R side, the bus voltage V_{BUS} will be described as the bus voltage V_{BUS_SNK} via the USB cable 106 and the bus switch SW2, and charges the battery 402. The charging circuit 302 is constituted by a step-down DC/DC converter, a linear regulator, or a combination thereof.

A system voltage V_{SYS} corresponding to at least one of the bus voltage V_{BUS_SNK} and a voltage V_{BAT} of the battery 402 is supplied from the charging circuit 302 to the load circuit 406. The load circuit 406 includes a multi-channel power supply including a power management integrated circuit (IC), a DC/DC converter, a linear regulator, etc., a microcomputer, a liquid crystal display, a display driver, etc.

Data (power data object (PDO)) that defines the bus voltage V_{BUS} requested by the power receiving device 300R and a maximum current is defined in the power receiving side controller 310. When the electronic apparatus 102 and the electronic apparatus 400 are connected to each other, the feeding side controller 204 and the power receiving side controller 310 perform negotiation, and determine the voltage level of the bus voltage V_{BUS} on the basis of the PDO. In addition, the power receiving side controller 310 performs on-off control of the bus switch SW2.

FIG. 2 is an operation sequence diagram of the feeding system 100R in FIG. 1. When the feeding device 200R and the power receiving device 300R are connected to each other via the USB cable 106, the feeding side controller 204 detects the connection on the basis of the state of the CC port (S100). Specifically, the power receiving side controller 310t of the power receiving device 300R waits in a state in which the CC port is pulled down by a pull-down resistance (terminating resistance) Rd having a predetermined resistance value. When the feeding device 200R and the power receiving device 300R are connected to each other, a voltage corresponding to the pull-down resistance Rd on the power receiving device 300R side and the state of the feeding device 200R itself occurs at the CC port of the feeding device 200R. The feeding side controller 204 of the feeding device 200R can thus detect the connection of the power receiving device 300R (electronic apparatus 400) to the feeding device 200R.

Detecting the connection of the power receiving device 300R to the feeding device 200R, the feeding device 200R turns on the bus switch SW1 (S102) and supplies a default bus voltage V_{BUS} of 5 V on condition that the voltage of the V_{BUS} terminal of the feeding device 200R itself is lower than a voltage level referred to as vSafe0V. The power receiving side controller 310 becomes operable when the bus switch SW1 is turned on. In the standard, vSafe0V is defined between 0.0 and 0.8 V.

Next, the feeding side controller 204 and the power receiving side controller 310 perform negotiation, and determine the bus voltage V_{BUS} (S104). The feeding side controller 204 changes the bus voltage V_{BUS} from the initial voltage of 5 V to the requested voltage (S106).

When the changing of the bus voltage V_{BUS} to the requested voltage is completed, notification of the completion is made from the feeding side controller 204 to the power receiving side controller 310 (S108). In response to this notification, the power receiving side controller 310 turns on the bus switch SW2 (S110). The bus voltage V_{BUS} is thereby supplied to the charging circuit 302 and the load circuit 406 (S112).

One example of the related art is Japanese Patent No. 6838879.

### SUMMARY

The present inventor has investigated reconnection between the source and the sink of a USB Type-C, and has identified the following problems.

FIG. 3 is a diagram of assistance in explaining reconnection between the source and the sink. V_{BUS_SRC} denotes the voltage of the VBUS terminal on the source side. V_{BUS_SNK} denotes the voltage of the VBUS terminal on the sink side.

Before time t₀, the sink (power receiving device) 300R and the source (feeding device) 200R are connected to each other by the USB cable, and a bus voltage V_{BUS} of 5 V is supplied from the source 200R to the sink 300R.

When the USB cable is disconnected at time t₀, the output switch SW1 of the source 200R is turned off, a discharge path not illustrated conducts, and a capacitor C1 is discharged. The voltage V_{BUS_SRC} thereby decreases toward 0 V. Meanwhile, the switch SW2 is turned off in the sink 300R.

As illustrated in FIG. 1, a capacitor C2 is connected to a VBUS pin of the sink 300R. After the switch SW2 is turned off, the discharge path of the capacitor C2 is lost, and therefore the voltage V_{BUS_SNK} of the VBUS terminal of the sink 300R decreases very slowly.

At time t₁, the source 200R and the sink 300R are connected to each other by the USB cable again. The feeding side controller 204 detects that the sink 300R is connected, on the basis of the state of the CC port.

The charge of the capacitor C2 of the sink 300R is supplied to the VBUS pin of the source 200R, so that the voltage V_{BUS_SRC} rises. As a result, the voltage V_{BUS_SRC} exceeds the threshold voltage vSafe0V.

The voltages V_{BUS_SRC} and V_{BUS_SNK} thereafter decrease. When the voltage V_{BUS_SRC} falls below the threshold value vSafe0V at time t₂, the feeding side controller 204 turns on the bus switch SW1. The voltage of 5 V generated by the power supply circuit 202 is thereby supplied to the sink 300R.

That is, in the feeding system 100R of FIG. 1, a delay occurs between time t₁ at which the source 200R and the sink 300R are connected to each other and time t₂ at which feeding is started. This delay is lengthened depending on the capacitance of the capacitor C2.

The present disclosure has been made in view of such problems. It is desirable to provide a system that can start feeding in a short time after connecting a source and a sink to each other.

An embodiment of the present disclosure relates to a USB port controller on a sink side. The USB port controller is compatible with a USB Type-C. A sink equipped with the USB port controller includes a power supply terminal, a capacitor connected to the power supply terminal, and a discharge resistance and a discharge switch connected in series with each other between the power supply terminal and a ground line. The USB port controller includes a discharge control unit configured to turn on the discharge switch when no voltage is supplied from a source to the power supply terminal.

Another embodiment of the present disclosure is an electronic apparatus. This electronic apparatus includes a USB receptacle including a power supply terminal and a grounding terminal, an internal circuit, a capacitor connected between the power supply terminal and a ground line, an input switch connected between the power supply terminal and the internal circuit, a discharge resistance and a discharge switch connected in series with each other between the power supply terminal and the ground line, and a discharge control unit configured to turn on the discharge switch when no voltage is supplied from a source to the power supply terminal.

According to an embodiment of the present disclosure, feeding can be started in a short time after connection between a source and a sink.

### BRIEF DESCRIPTION OF THE DRAWINGS

FIG. 1 is a block diagram of a feeding system;

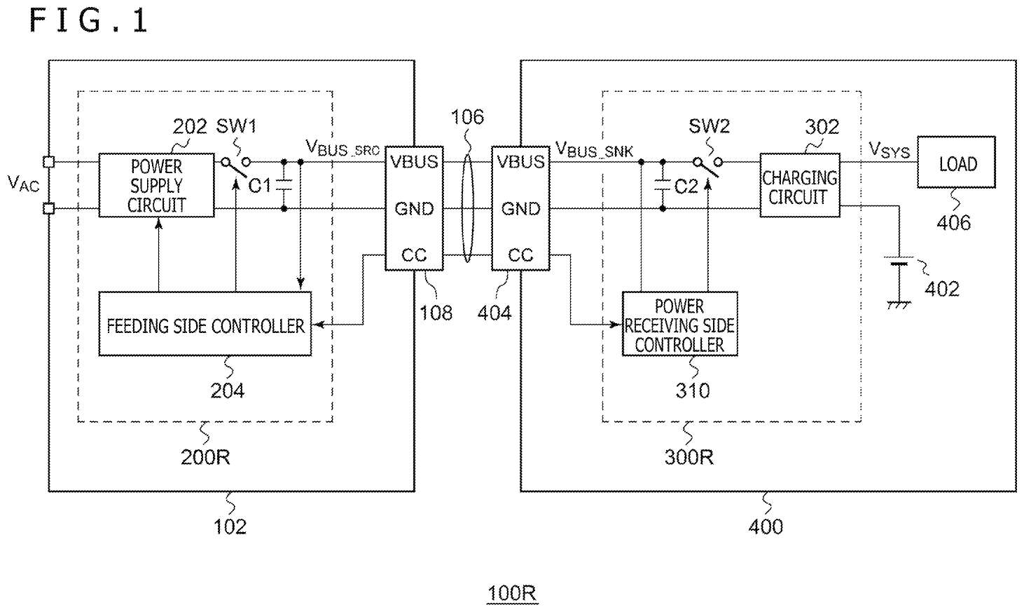

FIG. 2 is an operation sequence diagram of the feeding system of FIG. 1;

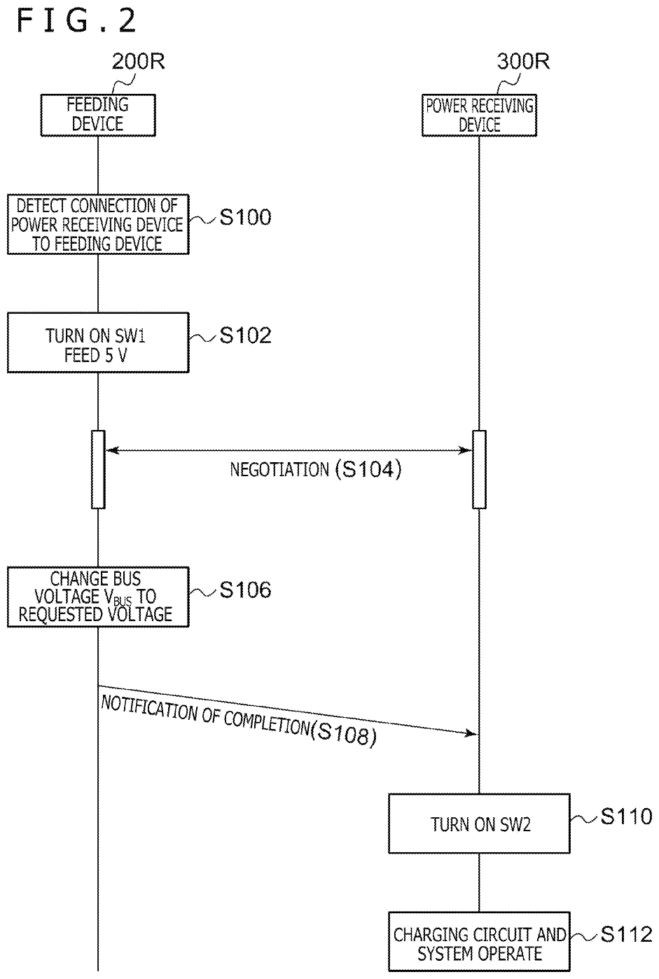

FIG. 3 is a diagram of assistance in explaining reconnection between a source and a sink;

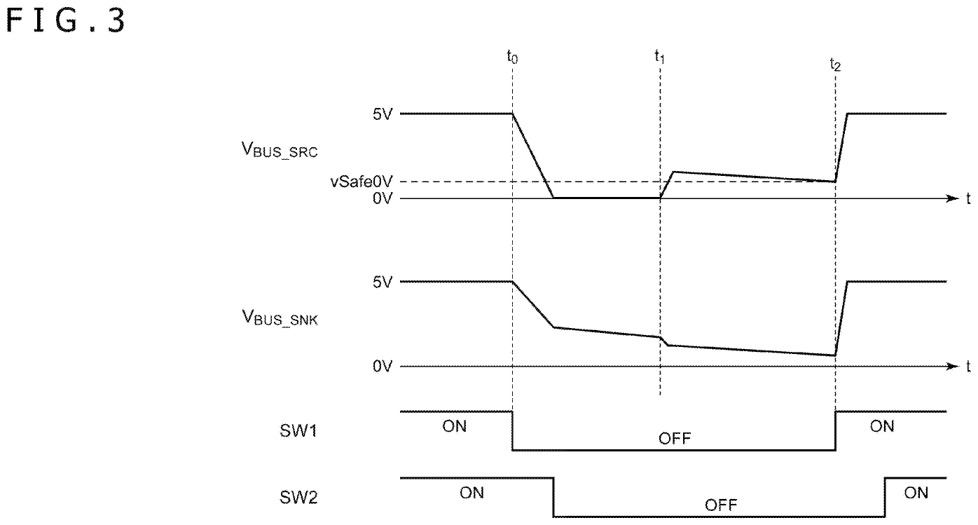

FIG. 4 is a block diagram of a feeding system according to an embodiment;

FIG. 5 is a diagram of assistance in explaining operation performed at a time of reconnection between a feeding device and a power receiving device in the feeding system of FIG. 4;

FIG. 6 is a circuit diagram illustrating an example of a configuration of a discharge switch and a discharge control unit;

FIG. 7 is a circuit diagram illustrating a modification of the discharge switch and the discharge control unit;

FIG. 8 is a circuit diagram illustrating a modification of the discharge switch and the discharge control unit; and

FIG. 9 is a circuit diagram illustrating another configuration example of the discharge switch and the discharge control unit.

### DETAILED DESCRIPTION OF THE PREFERRED EMBODIMENTS

### Outline of Embodiments

An outline of a few illustrative embodiments of the present disclosure will be described. This outline describes, in a simplified manner, a few concepts of one or a plurality of embodiments as an introduction to the following detailed description for a purpose of basic understanding of the embodiments, and does not limit the scope of the technology or the disclosure. This outline is neither a comprehensive outline of all conceivable embodiments nor intended to identify important elements of all of the embodiments or demarcate the scope of a part or all of embodiments. For convenience, “one embodiment” may be used to refer to one embodiment (an example or a modification) or a plurality of embodiments (examples or modifications) disclosed in the present specification.

A USB port controller according to one embodiment is compatible with a USB Type-C. A sink equipped with the USB port controller includes a power supply terminal, a capacitor connected to the power supply terminal, and a discharge resistance and a discharge switch connected in series with each other between the power supply terminal and a ground line. The USB port controller includes a discharge control unit configured to turn on the discharge switch when no voltage is supplied from a source to the power supply terminal.

When the discharge switch provided to the sink is turned on while the source is not connected to the sink, the charge of the capacitor is discharged, and the voltage of the power supply terminal is decreased. Hence, when the source is connected to the sink next time, the remaining charge of the capacitor is zero or very small, so that a rise in the voltage of the power supply terminal of the source is suppressed. Thus, at a time of reconnection, the voltage of the power supply terminal of the source is lower than a threshold voltage. A bus switch (output switch) of the source is therefore immediately turned on, so that feeding can be started in a short time.

In one embodiment, the discharge switch may be included in the USB port controller.

In one embodiment, the discharge resistance may be included in the USB port controller.

In one embodiment, the discharge switch may be a depletion transistor. The discharge control unit may apply an off-level driving voltage to a control terminal of the discharge switch when a voltage is supplied from the source to the power supply terminal.

In one embodiment, the USB port controller may be integrated on one semiconductor substrate. “integrated” includes a case where all of circuit constituent elements are formed on the semiconductor substrate and a case where main circuit constituent elements are integrated. A part of resistances, capacitors, etc., may be provided on the outside of the semiconductor substrate, for adjustment of circuit constants. Integrating the circuit on one chip can reduce a circuit area and hold characteristics of the circuit elements uniform.

An electronic apparatus according to one embodiment includes a USB receptacle including a power supply terminal and a grounding terminal, an internal circuit, a capacitor connected between the power supply terminal and a ground line, an input switch connected between the power supply terminal and the internal circuit, a discharge resistance and a discharge switch connected in series with each other between the power supply terminal and the ground line, and a discharge control unit configured to turn on the discharge switch when no voltage is supplied from a source to the power supply terminal.

In one embodiment, the discharge switch may be a depletion transistor, and the discharge control unit may apply an off-level driving voltage to a control terminal of the discharge switch when a voltage is supplied from the source to the power supply terminal.

### Embodiment

A preferred embodiment will hereinafter be described with reference to the drawings. Identical or equivalent constituent elements, members, and processing illustrated in each drawing are identified by the same reference numerals, and repeated description thereof will be omitted as appropriate. In addition, the embodiment is not restrictive of the disclosure and the technology but is illustrative, and all features described in the embodiment and combinations thereof are not necessarily essential to the disclosure and the technology.

In the present specification, a “state in which a member A is connected to a member B” includes not only a case where the member A and the member B are physically directly connected to each other but also a case where the member A and the member B are indirectly connected to each other via another member that does not essentially affect a state of electric connection between the member A and the member B or does not impair functions or effects produced by the coupling of the member A and the member B.

Similarly, a “state in which a member C is connected (provided) between the member A and the member B” includes not only a case where the member A and the member C or the member B and the member C are directly connected to each other but also a case where the member A and the member C or the member B and the member C are indirectly connected to each other via another member that does not essentially affect a state of electric connection between the member A and the member C or the member B and the member C or does not impair functions or effects produced by the coupling of the member A and the member C or the member B and the member C.

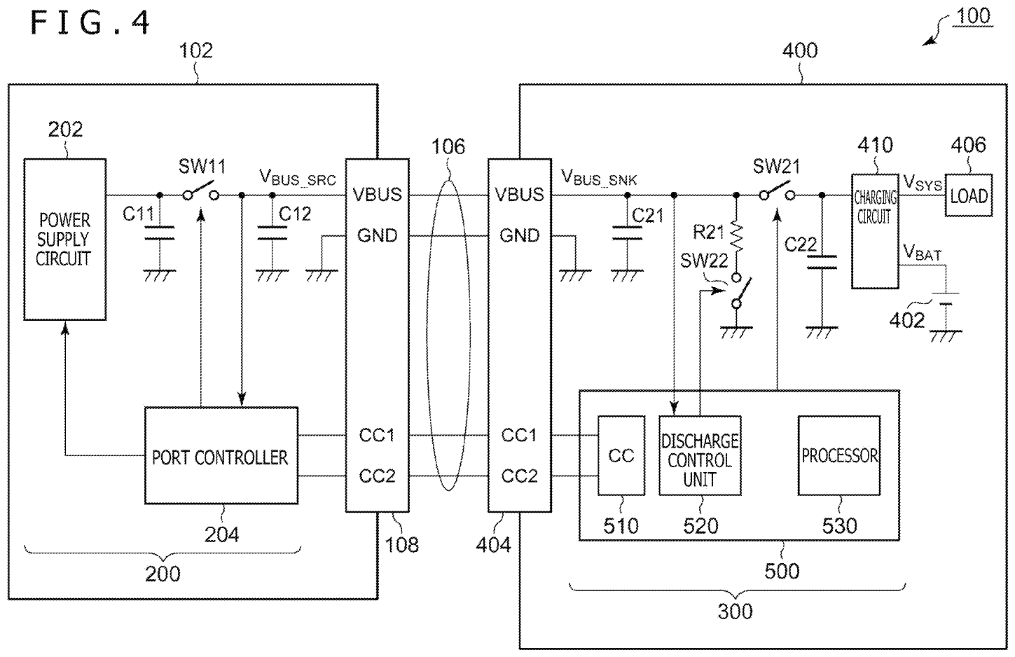

FIG. 4 is a block diagram of a feeding system 100 according to an embodiment. The feeding system 100 is compliant with a USB Type-C standard. The feeding system 100 includes a feeding device (referred to also as a source) 200 and a power receiving device (referred to also as a sink) 300. The feeding device 200 and the power receiving device 300 are connected to each other via a USB cable 106.

The feeding device 200 is, for example, included in an electronic apparatus 102. The electronic apparatus 102 may be an AC adapter. The power receiving device 300 is included in a battery driven type electronic apparatus 400 such as a smart phone, a tablet terminal, a digital camera, a digital video camera, or a portable audio player.

A configuration of the source side, that is, the electronic apparatus 102 side will first be described.

The electronic apparatus 102 includes the feeding device 200 and a receptacle 108. The feeding device 200 includes a power supply circuit 202, a feeding side PD controller (hereinafter referred to as a feeding side controller) 204, a bus switch SW11, and capacitors C11 and C12. The USB cable 106 is detachably connected to the receptacle 108 of the electronic apparatus 400. Incidentally, there is also a charge adapter in which the receptacle 108 is omitted and the USB cable 106 is integral with the electronic apparatus 102.

The receptacle 108 includes a VBUS terminal for supplying a bus voltage V_{BUS}, a GND terminal for supplying a ground voltage V_{GND} (0 V), and CC ports.

The power supply circuit 202 generates the bus voltage V_{BUS}. The power supply circuit 202 may include an AC/DC converter that receives AC 100 V from an external power supply (for example, a commercial alternating-current power supply) not illustrated and converts AC 100 V into a direct-current bus voltage V_{BUS}. The bus voltage V_{BUS} generated by the power supply circuit 202 is supplied to the power receiving device 300 via a bus line of the USB cable 106 and the bus switch SW11.

The feeding side controller 204 is a port controller for a USB Type-C and a USB-PD. The feeding side controller 204 and a USB port controller 500 are connected to each other via CC lines. The feeding side controller 204 can detect that the power receiving device 300 is connected to the feeding device 200, on the basis of the state of CC pins on the USB port controller 500 side. In addition, the feeding side controller 204 and the USB port controller 500 can communicate with each other via the CC lines. The feeding side controller 204 and the USB port controller 500 negotiate the voltage level of the bus voltage V_{BUS} to be supplied by the feeding device 200. The feeding side controller 204 controls the power supply circuit 202 so as to provide the determined voltage level, and performs on-off control of the bus switch SW11.

In the USB Type-C standard, after the feeding side controller 204 detects the connection of the power receiving device 300 to the feeding device 200, the feeding side controller 204 turns on the bus switch SW11 on condition that the bus voltage V_{BUS_SRC} of the VBUS terminal is lower than a predetermined threshold value vSafe0V.

A configuration of the sink side, that is, the electronic apparatus 400 will next be described.

The electronic apparatus 400 includes a battery 402, a receptacle 404, a load (system) circuit 406, and the power receiving device 300. The battery 402 is a rechargeable secondary battery. The load circuit 406 includes a CPU, a memory, a liquid crystal display, an audio circuit, etc. The electronic apparatus 102 is detachably connected to the receptacle 404 via the USB cable 106.

The power receiving device 300 receives power from the electronic apparatus 102, and charges a charging circuit 410. The power receiving device 300 includes the charging circuit 410, the USB port controller 500, a bus switch SW21, capacitors C21 and C22, a discharge resistance R21, and a discharge switch SW22.

The charging circuit 410 receives the bus voltage V_{BUS} from the feeding device 200 via the USB cable 106 and the bus switch SW21, and charges the battery 402. On the power receiving device 300 side, the bus voltage V_{BUS} will be referred to also as an input voltage, and described as V_{BUS_SNK}. The charging circuit 410 is constituted by a step-down DC/DC converter, a linear regulator, or a combination thereof.

A system voltage V_{SYS} corresponding to at least one of the bus voltage V_{BUS_SNK} and a voltage V_{BAT} of the battery 402 is supplied from the charging circuit 410 to the load circuit 406. The load circuit 406 includes a multi-channel power supply including a power management IC, a DC/DC converter, a linear regulator, etc., a microcomputer, a liquid crystal display, a display driver, etc.

The capacitors C21 and C22 are connected to both ends of the bus switch SW21. In addition, the discharge resistance R21 and the discharge switch SW22 are connected between the VBUS terminal of the receptacle 404 and the ground line and in parallel with the capacitor C21.

The USB port controller 500 includes a CC pin circuit 510, a discharge control unit 520, and a processor 530. The CC pin circuit 510 includes a pull-down resistance that pulls down the CC pins. Incidentally, in a case where the power receiving device 300 has a dual power role (DPR) that allows switching between the sink and the source, the CC pin circuit 510 is configured to be switchable between a state in which the CC pins are pulled down (that is, the sink) and a state in which the CC pins are pulled up (that is, the source).

As described above, the USB port controller 500 performs negotiation with the feeding side controller 204 via the CC lines. A transceiver for communication via the CC lines is included in the CC pin circuit 510.

Data (PDO) that defines the bus voltage V_{BUS} requested by the power receiving device 300 and a maximum current is defined in the USB port controller 500. When the electronic apparatus 102 and the electronic apparatus 400 are connected to each other, the feeding side controller 204 and the USB port controller 500 perform negotiation, and determine the voltage level of the bus voltage V_{BUS} on the basis of the PDO. In addition, the USB port controller 500 performs on-off control of the bus switch SW21. The processor 530 executes a software program, and thereby performs negotiation with the feeding side controller 204. The processor 530 may be a microcontroller independent of the USB port controller 500.

The discharge control unit 520 monitors the voltage V_{BUS_SNK} of the VBUS terminal of the receptacle 404. The discharge control unit 520 is configured to turn on the discharge switch SW22 when the bus voltage V_{BUS} is not supplied from the electronic apparatus 102 to the VBUS terminal. The discharge control unit 520 turns off the discharge switch SW22 when detecting that the bus voltage V_{BUS} is supplied from the electronic apparatus 102 to the VBUS terminal.

A configuration of the feeding system 100 has been described above. Operation thereof will next be described.

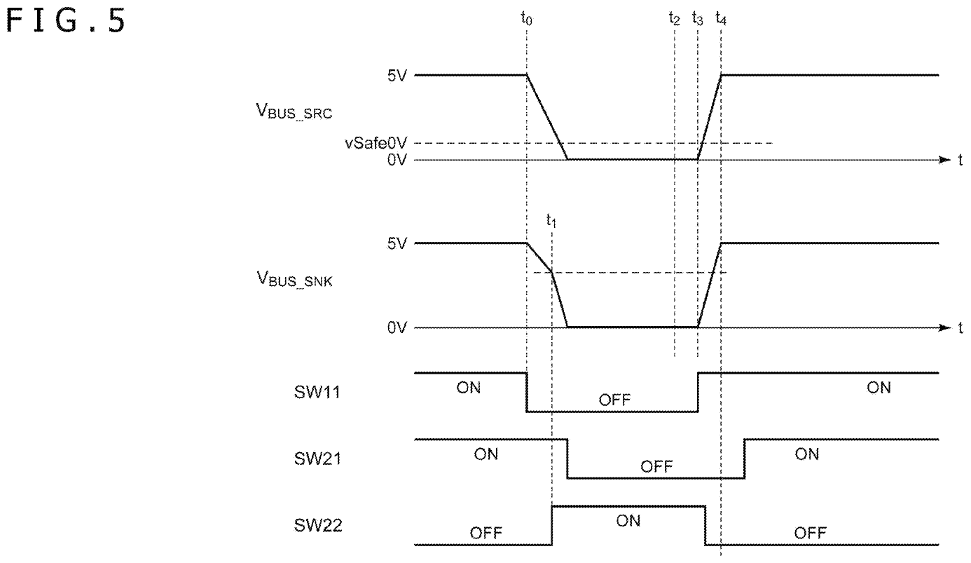

FIG. 5 is a diagram of assistance in explaining operation performed at a time of reconnection between the feeding device 200 and the power receiving device 300 in the feeding system 100 of FIG. 4.

Before time t₀, the power receiving device 300 and the feeding device 200 are connected to each other by the USB cable 106, and a bus voltage V_{BUS} of 5 V is supplied from the feeding device 200 to the power receiving device 300.

In this state, the VBUS terminal of the receptacle 404 is supplied with the bus voltage V_{BUS} of 5 V, and therefore the discharge control unit 520 holds the discharge switch SW22 off.

When the USB cable 106 is disconnected at time to, the bus switch SW11 of the feeding device 200 is turned off, a discharge path not illustrated conducts, the capacitor C12 is discharged, and the voltage V_{BUS_SRC} decreases toward 0 V. The USB port controller 500 turns off the bus switch SW21.

When the USB cable 106 is disconnected, the voltage V_{BUS_SNK} on the power receiving device 300 side decreases. When the discharge control unit 520 detects the decrease in the voltage V_{BUS_SNK} at time t₁, the discharge control unit 520 determines that the feeding of the bus voltage V_{BUS} is stopped, and turns on the discharge switch SW22. Consequently, the capacitor C21 is discharged, and the voltage V_{BUS_SNK} rapidly decreases to 0 V.

At time t₂, the feeding device 200 and the power receiving device 300 are connected to each other by the USB cable 106 again. The feeding side controller 204 of the feeding device 200 detects that the power receiving device 300 is connected to the feeding device 200, on the basis of the state of the CC ports.

At time t₂, the charge of the capacitor C21 of the power receiving device 300 is zero. Hence, even when the feeding device 200 and the power receiving device 300 are connected to each other, the voltage V_{BUS_SRC} does not rise, and the voltage V_{BUS_SRC} maintains a state of being lower than the threshold voltage vSafe0V.

At time t₃, when the feeding side controller 204 detects that the voltage V_{BUS_SRC} is lower than the threshold value vSafe0V, the feeding side controller 204 turns on the bus switch SW11. Consequently, the voltages V_{BUS_SRC} and V_{BUS_SNK} rise.

In the power receiving device 300, when the discharge control unit 520 detects that the bus voltage V_{BUS_SNK} is supplied, the discharge control unit 520 turns off the discharge switch SW22. Consequently, a discharge path including the discharge resistance R21 and the discharge switch SW22 is interrupted.

Operation of the feeding system 100 has been described above.

According to this feeding system 100, when the feeding device 200 is not connected to the power receiving device 300, the discharge switch SW22 provided to the power receiving device 300 is turned on. Consequently, the charge of the capacitor C21 is discharged, and the voltage V_{BUS_SNK} of the VBUS terminal is decreased. Hence, when the feeding device 200 is connected to the power receiving device 300 next time, the remaining charge of the capacitor C21 is zero or very small, so that a rise in the voltage V_{BUS_SRC} of the VBUS terminal of the feeding device 200 can be suppressed. Thus, at a time of reconnection, the voltage V_{BUS_SRC} is lower than the threshold voltage vSafe0V, so that the bus switch SW11 of the feeding device 200 is immediately turned on, and feeding can be started in a short time.

When the bus voltage V_{BUS} is supplied from the feeding device 200 to the power receiving device 300, the discharge switch SW22 is off, and therefore unnecessary power consumption in the discharge path can be prevented.

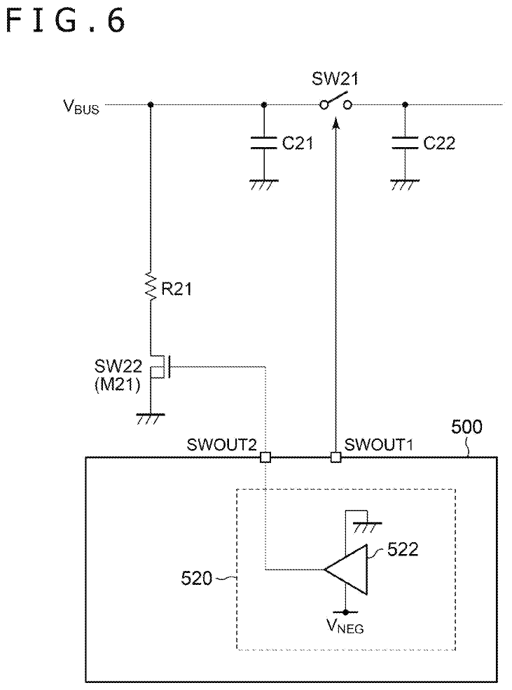

FIG. 6 is a circuit diagram illustrating an example of a configuration of the discharge switch SW22 and the discharge control unit 520. The discharge control unit 520 needs to be on in a state in which the power supply voltage V_{BUS} is not supplied to the USB port controller 500. The discharge switch SW22 includes a transistor M21. The transistor M21 is a depletion N-channel metal oxide semiconductor field effect transistor (MOSFET).

The discharge control unit 520 includes a driver 522. The driver 522 is inoperable and outputs 0 V when the power supply voltage V_{BUS} is not supplied. The depletion MOSFET is a normally on device. The depletion MOSFET is set in an on state by a gate voltage of 0 V.

The driver 522 becomes operable when the power supply voltage V_{BUS} is supplied. The driver 522 can select and output a negative driving voltage V_{NEG} in an operable state. The driver 522 may include a negative charge pump. The discharge switch SW22 can be turned off by application of the negative voltage V_{NEG} to the gate of the depletion MOSFET discharge switch SW22.

The driver 522 may be configured to output the negative voltage V_{NEG} at all times in the operable state in which the power supply voltage V_{BUS} is supplied. Alternatively, the driver 522 may be configured to be able to control the output between 0 V and the negative voltage V_{NEG} in the operable state. In addition, the positions of the discharge switch SW22 and the discharge resistance R21 may be interchanged.

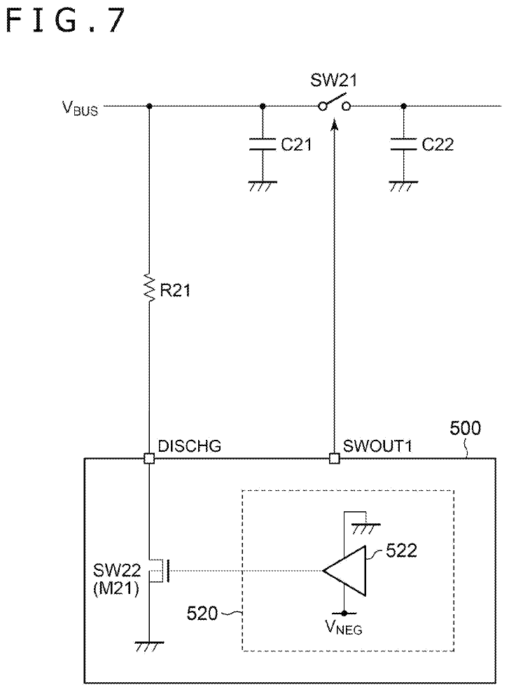

FIG. 7 is a circuit diagram illustrating a modification of the discharge switch SW22 and the discharge control unit 520. In this modification, the transistor M21 as the discharge switch SW22 is integrated in the USB port controller 500. The USB port controller 500 has a discharge pin DISCHG. The transistor M21 is connected between the discharge pin DISCHG and the ground line. The discharge resistance R21 is connected between the discharge pin DISCHG of the USB port controller 500 and the VBUS terminal. According to this modification, the number of external parts can be reduced.

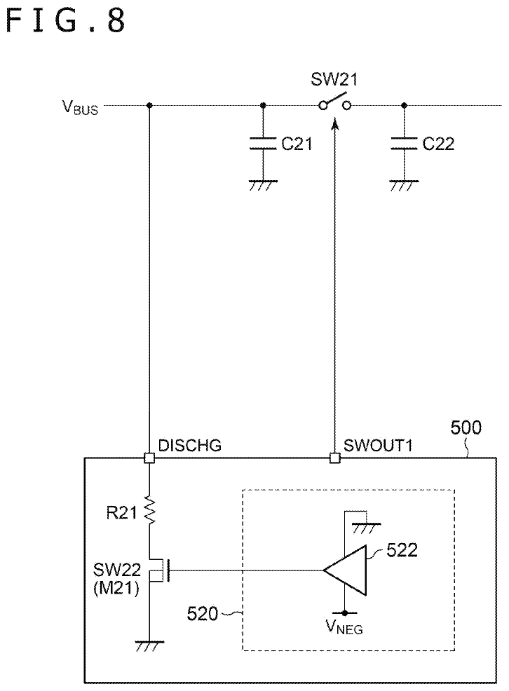

FIG. 8 is a circuit diagram illustrating a modification of the discharge switch SW22 and the discharge control unit 520. In this modification, in addition to the transistor M21, the discharge resistance R21 is integrated in the USB port controller 500. The USB port controller 500 has a discharge pin DISCHG. The transistor M21 and the discharge resistance R21 are connected between the discharge pin DISCHG and the ground line. The transistor M21 and the discharge resistance R21 may be interchanged. The discharge pin DISCHG of the USB port controller 500 is directly connected to the VBUS terminal. According to this modification, the number of external parts can be further reduced.

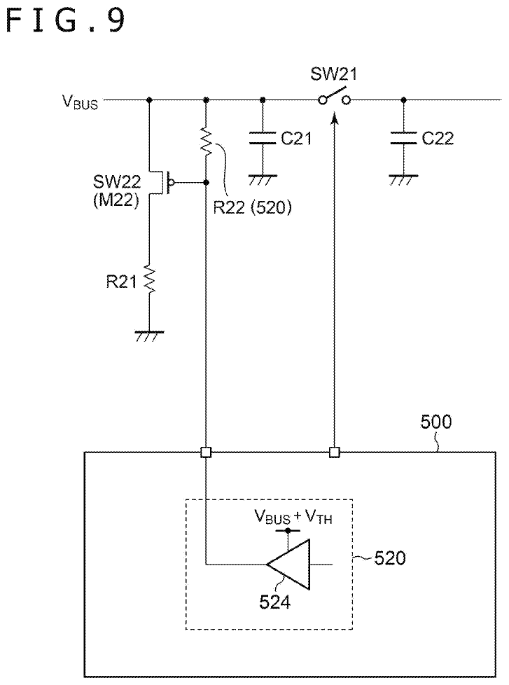

FIG. 9 is a circuit diagram illustrating another configuration example of the discharge switch SW22 and the discharge control unit 520. The discharge switch SW22 includes a transistor M22. The transistor M22 is a depletion P-channel MOSFET.

The discharge control unit 520 includes a pull-up resistance R22 connected between the gate and the source of the transistor M22 and a driver 524 that controls the gate of the transistor M22. The output of the driver 524 has a high impedance in an inoperable state in which the power supply voltage V_{BUS} is not supplied. At this time, the gate and the source of the transistor M22 are short-circuited by the pull-up resistance R22. Thus, a gate-to-source voltage is 0 V, and the discharge switch SW22 is on.

The driver 524 outputs a voltage higher than the voltage V_{BUS} in an operable state in which the power supply voltage V_{BUS} is supplied. The transistor M22 is thereby turned off.

In the case of FIG. 9, at least one of the transistor M22, the discharge resistance R21, and the pull-up resistance R22 may be integrated in the USB port controller 500.

The embodiments are illustrative, and it is to be understood by those skilled in the art that there are various modifications of combinations of constituent elements and processing processes of those embodiments and that such modifications are also included in the scope of the present disclosure or the present technology.

What is claimed is:

1. A universal serial bus port controller on a sink side, the universal serial bus port controller being compatible with a universal serial bus Type-C,
a sink equipped with the universal serial bus port controller including
a power supply terminal,
a capacitor connected to the power supply terminal, and
a discharge resistance and a discharge switch connected in series with each other between the power supply terminal and a ground line,
the universal serial bus port controller comprising:
a discharge control unit configured to turn on the discharge switch when no voltage is supplied from a source to the power supply terminal.

2. The universal serial bus port controller according to claim 1, wherein
the discharge switch is included in the universal serial bus port controller.

3. The universal serial bus port controller according to claim 1, wherein
the discharge resistance is included in the universal serial bus port controller.

4. The universal serial bus port controller according to claim 1, wherein
the discharge switch is a depletion transistor, and
the discharge control unit applies an off-level driving voltage to a control terminal of the discharge switch when a voltage is supplied from the source to the power supply terminal.

5. The universal serial bus port controller according to claim 1, wherein
the universal serial bus port controller is integrated on one semiconductor substrate.

6. An electronic apparatus comprising:
the universal serial bus port controller according to claim 1.

7. An electronic apparatus comprising:
a universal serial bus receptacle including a power supply terminal and a grounding terminal;
an internal circuit;
a capacitor connected between the power supply terminal and a ground line;
an input switch connected between the power supply terminal and the internal circuit;
a discharge resistance and a discharge switch connected in series with each other between the power supply terminal and the ground line; and
a discharge control unit configured to turn on the discharge switch when no voltage is supplied from a source to the power supply terminal.

8. The electronic apparatus according to claim 7, wherein
the discharge switch is a depletion transistor, and
the discharge control unit applies an off-level driving voltage to a control terminal of the discharge switch when a voltage is supplied from the source to the power supply terminal.
